(19) United States
(12) Patent Application Publication
(10) Pub. No.: US 2025/0077136 A1
(43) Pub. Date: Mar. 6, 2025

(54) PRINTING APPARATUS AND CONTROL METHOD OF PRINTING APPARATUS

(71) Applicant: CANON KABUSHIKI KAISHA, Tokyo (JP)

(72) Inventors: YUKI OHIRA, Tokyo (JP); MIZUKI SEO, Kanagawa (JP)

(21) Appl. No.: 18/791,610

(22) Filed: Aug. 1, 2024

(30) Foreign Application Priority Data
Aug. 29, 2023 (JP) 2023-138895

(51) Int. Cl. G06F 3/12

(52) U.S. Cl. CPC G06F 3/121; G06F 3/1236

(57) ABSTRACT

A printing apparatus configured to print an image by ejecting a liquid onto a printing medium includes: an electric substrate including a pair of detection terminals including a wiring pattern configured to detect connection and a liquid leak of the electric substrate, and an element having a resistance component between the pair of detection terminals; and one or more processors and/or circuitry which function as: a determination unit configured to determine a connection state of the electric substrate and whether the liquid leak occurs in a portion in which the electric substrate is arranged, based on an obtained voltage between the pair of detection terminals, a first threshold related to the connection detection of the electric substrate, and a second threshold which is a value different from the first threshold and related to the liquid leak.

### BACKGROUND OF THE INVENTION

### Field of the Invention

The present disclosure relates to a technique of liquid leak detection.

### Description of the Related Art

Regarding a printing apparatus that forms an image by ejecting a liquid (hereinafter, also referred to as “ink”) onto a printing medium, Japanese Patent Laid-Open No. 2008-254362 discloses a method of detecting a leak of the liquid by using a change in a resistance value between electrodes.

### SUMMARY OF THE INVENTION

A printing apparatus according to the present disclosure is a printing apparatus configured to print an image by ejecting a liquid onto a printing medium, including: an electric substrate including a pair of detection terminals including a wiring pattern configured to detect connection and a liquid leak of the electric substrate, and an element having a resistance component between the pair of detection terminals; and one or more processors and/or circuitry which function as: a determination unit configured to determine a connection state of the electric substrate and whether the liquid leak occurs in a portion in which the electric substrate is arranged, based on an obtained voltage between the pair of detection terminals, a first threshold related to the connection detection of the electric substrate, and a second threshold which is a value different from the first threshold and related to the liquid leak.

Further features of the present disclosure will become apparent from the following description of exemplary embodiments with reference to the attached drawings.

### BRIEF DESCRIPTION OF THE DRAWINGS

FIGS. 1A and 1B are perspective views illustrating a configuration of an ink jet printing apparatus;

FIG. 2 is a block diagram illustrating a control configuration of the printing apparatus;

FIG. 3 is an exterior view of a liquid leak detection unit;

FIG. 4 is a block diagram of a circuit of connection detection and liquid leak detection of the liquid leak detection unit;

FIG. 5 is a flowchart illustrating processing of connection determination and liquid leak determination;

FIGS. 6A, 6B, and 6C are diagrams illustrating time changes of an obtained voltage in a normal time, in a connection abnormal time, and in a case where a liquid leak occurs;

FIGS. 7A, 7B, and 7C are diagrams illustrating time changes of the obtained voltage in the normal time, in the connection abnormal time, and in the case where the liquid leak occurs;

FIG. 8 is an exterior view of the liquid leak detection unit;

FIGS. 9A and 9B are diagrams illustrating time changes of an obtained voltage in the normal time and in the connection abnormal time;

FIGS. 10A and 10B are diagrams illustrating time changes of an obtained voltage in the normal time and in the case where the liquid leak occurs;

FIG. 11 is an exterior view of the liquid leak detection unit;

FIGS. 12A and 12B are diagrams illustrating time changes of the obtained voltage in the normal time and in the connection abnormal time; and

FIG. 13 is an exterior view of the liquid leak detection unit.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. In addition, the same components are denoted by the same reference numerals. Further, each process (step) in the flowcharts and the sequence charts is denoted by a reference numeral starting with S.

In this specification, the terms “print” and “printing” not only include the formation of significant information such as characters and graphics, but also broadly includes the formation of images, figures, patterns, and the like on a print medium, or the processing of the medium, regardless of whether they are significant or insignificant and whether they are so visualized as to be visually perceivable by humans. Also, the term “print medium (or sheet)” not only includes a paper sheet used in common printing apparatuses, but also broadly includes materials, such as cloth, a plastic film, a metal plate, glass, ceramics, wood, and leather, capable of accepting ink. In addition, the “ink” (which may be also referred to as a “liquid”) should be broadly interpreted in the same way as in the above definition of “printing”. Hence, the “ink” means a liquid that is applied onto a print medium to form images, designs, patterns, and the like or to process a print medium, or a liquid that can be provided for ink processing (for example, solidification, insolubilization, or the like of colorants in ink that is applied to a print medium).

### First Embodiment

### <Overall Configuration>

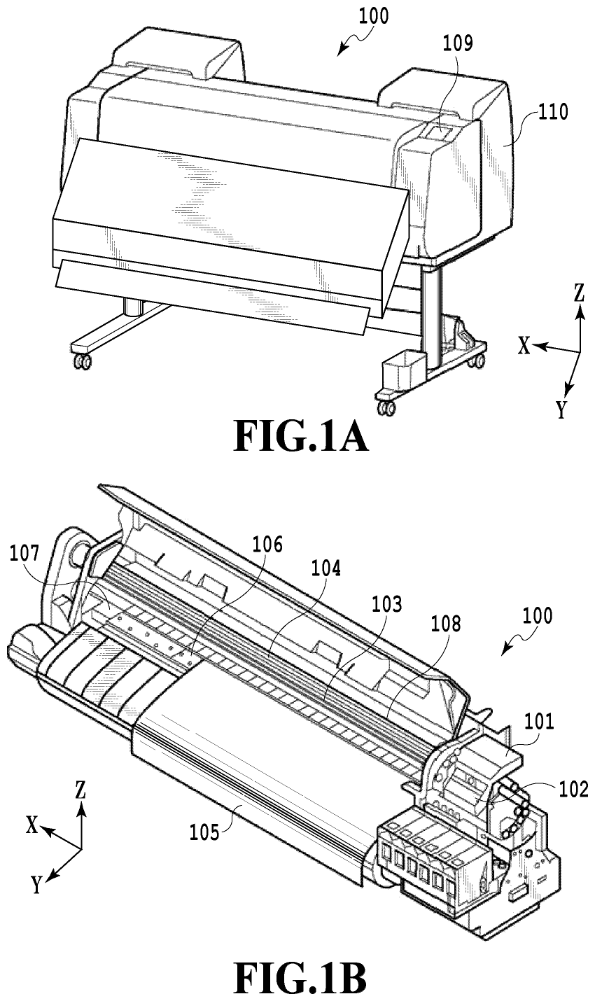

FIGS. 1A and 1B are exterior perspective views of an ink jet printing apparatus 100 according to the present disclosure. FIG. 1A illustrates the appearance of the ink jet printing apparatus 100. FIG. 1B illustrates an internal structure with an opened top cover in FIG. 1A. The printing apparatus 100 in the present embodiment performs printing by applying a liquid (ink) as a printing material onto a printing medium by an ink jet printing method. The printing medium is conveyed in a Y direction as a conveyance direction. Here is described an ink jet printing apparatus including a so-called serial type printing head that performs printing with a carriage 101, on which a printing head 102 is mounted, reciprocally moving in an X direction that crosses the Y direction. An ink jet printing apparatus including a so-called line type printing head in which a nozzle array is formed over a printing width in the conveyance direction of the printing medium may also be used. Note that, by the more common thought that the ink is a “liquid”, the ink jet printing apparatus may be construed also as a liquid ejection printing apparatus.

The carriage 101 includes the printing head 102 in which an ejection port surface provided with an ejection port to eject the liquid supplied from a liquid tank in a liquid tank storage unit 110 via a liquid tube 108 is formed. The carriage 101 is configured to be reciprocally movable in the X direction (a movement direction of the carriage 101) along a shaft 104 via a carriage belt 103 by driving a not-illustrated carriage motor. A printing medium 105 such as roll paper is conveyed by a not-illustrated conveyance roller on a platen 106 in the Y direction. A printing operation is performed with the printing head 102 ejecting the liquid while the carriage 101 is moved in the X direction above the printing medium 105 conveyed onto the platen 106 by the conveyance roller.

The printing apparatus 100 includes an input and output unit 109 on the top. The input and output unit 109 is an operation panel and displays a liquid remaining amount and a candidate of a type of the printing medium on a display. A user can select the type of the printing medium and make printing setting by operating the operation panel. Additionally, in a case where an error occurs, the user can confirm details of the error based on an error notification number displayed on the operation panel.

On a back surface of the printing apparatus 100, the liquid tank storage unit 110 that stores liquid tanks of black, cyan, magenta, yellow, and the like and supplies the liquid to the printing head is arranged. A portion in which the liquid tank storage unit is arranged may not be the back surface, and the liquid tank storage unit may be independently arranged on a side of the printing apparatus 100. A liquid leak detection unit having a function of detecting a leak of the liquid is arranged in a liquid supply path from the liquid tank in the liquid tank storage unit 110 to the carriage 101. For example, it is preferable to arrange plural liquid leak detection units in portions with a high possibility of a liquid leak such as a bottom surface of the liquid tank storage unit 110 and a joined portion of the liquid tube 108.

### <Block Diagram of Control Configuration>

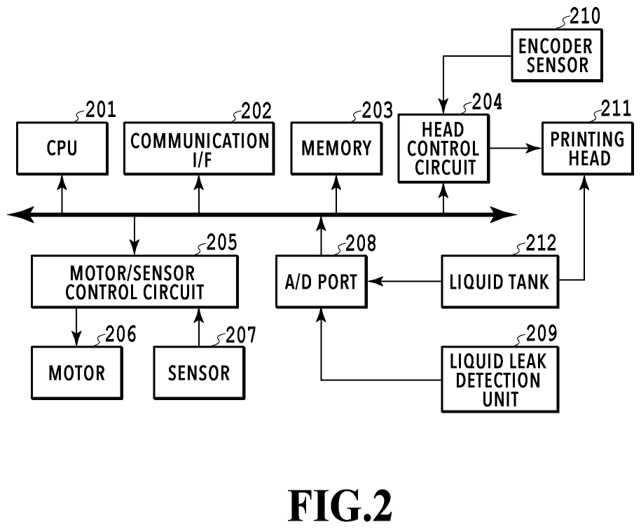

FIG. 2 is a block diagram illustrating a control configuration of the printing apparatus 100. A CPU 201 controls overall the printing apparatus 100. A communication I/F 202 controls communication with a host apparatus (a PC) via a wired LAN, a wireless LAN, a USB, or the like. A motor/sensor control circuit 205 controls a motor 206 that scans the carriage 101 and conveys the printing medium 105 and a sensor 207 that detects the printing medium 105.

The motor 206 is a motor such as a stepping motor or a DC motor. The motor 206 conveys the printing medium 105 and moves the carriage 101 on which a printing head 211 is mounted via a gear, a belt, and the like. The sensor 207 is an optical sensor or a mechanical sensor such as a mechanical lever. For example, in a case where the printing medium 105 passes through a sensor position, the sensor 207 detects the printing medium 105.

A memory 203 includes a ROM, a RAM, and the like. The memory 203 stores a control program of the CPU 201. The memory 203 is used as an image processing buffer that temporarily stores image data transferred from the host apparatus and received by the communication I/F 202, or used also as a working area. Additionally, the memory 203 also saves a reference voltage value and the like between electrodes that is generated in a case where a constant current is supplied in a state in which the liquid is reliably supplied into each liquid tank, such as in cleaning or a liquid filling operation.

A head control circuit 204 operates in synchronization with an encoder sensor 210 indicating a position of the printing head 211. Before scanning for printing, the CPU 201 provides the head control circuit 204 with a memory address of image data that should be read. With the printing head 211 moving above the printing medium, the head control circuit 204 reads the image data corresponding to the printing head position from the memory 203 and provides the printing head 211 with the image data and an ejection timing at the right time. Liquid leak detection units 209 are arranged in plural portions in the printing apparatus 100 and detect the liquid leak.

An A/D port 208 detects a voltage during detection of a remaining amount in the liquid tank and the liquid leak. In a liquid remaining amount detection function, the detection result of the A/D port 208 is reflected to information stored in the memory 203 and is used for the liquid remaining amount management of a liquid tank 212. In a liquid leak detection function, an A/D conversion value of the detected voltage is notified to the CPU 201. The CPU 201 determines whether the liquid leak occurs by using the A/D conversion value.

### <Liquid Leak Detection Unit Configuration>

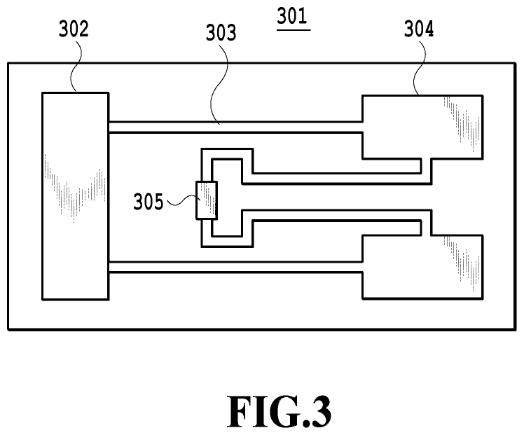

FIG. 3 is an exterior view schematically illustrating the liquid leak detection unit 209. The liquid leak detection unit 209 includes an electric substrate 301. On the electric substrate 301, a connector terminal 302 to connect the electric substrate 301 and the A/D port 208 with each other, a wiring pattern 303 to detect the liquid leak, a detection terminal 304, and an element 305 (a resistance element 305) having a resistance component are wired.

The wiring pattern 303 includes a pair (two electrodes) of wirings and a pair (two electrodes) of the detection terminals 304. The wiring of the wiring pattern 303 is etched in an electric substrate manufacturing process, and the surface is protected by resist material after a copper foil pattern is formed. On the electrode of the detection terminal 304, a pattern with gold plating is arranged on the substrate surface. In a case where the liquid is leaked, and the leak occurs between the two electrodes of the detection terminals 304, the liquid leak detection function is activated.

Additionally, the element 305 having the resistance component is arranged between the pair (two electrodes) of the detection terminals. For example, in a case where the electric substrate 301 is not connected, a fitting failure of the connector terminal 302 occurs, or a wire break of the wiring pattern 303 occurs, there is a possibility that the detection terminal 304 cannot perform the liquid leak detection properly. The element 305 having the resistance component determines whether the detection terminal 304 operates properly, and the CPU 201 can determine whether the liquid leak detection function operates properly.

In the present embodiment, with the connection determination of the liquid leak detection unit 209, whether the liquid leak detection function is normal is determined, and the liquid leak is detected. For example, in a case where it is difficult to arrange the electric substrate 301 in terms of a printer structure, a flexible substrate such as a flexible printed circuit (FPC) may be used. It is possible to provide the electric substrate 301 in a narrow portion by arranging on the FPC the pair (two electrodes) of the wirings and the pair (two electrodes) of the detection terminals that detect the liquid leak and the element having the resistance component between the pair (two electrodes) of the detection terminals.

### <Configuration of Liquid Leak Detection Circuit>

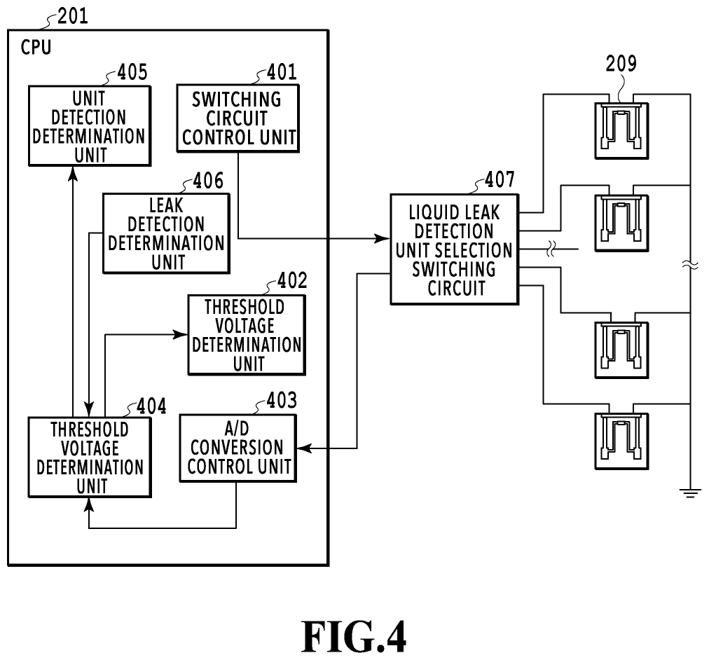

FIG. 4 is a diagram schematically illustrating a configuration of a circuit used for the connection determination and the detection of the liquid leak of the liquid leak detection unit 209. The CPU 201 uses units 401 to 406 to implement various processing functions necessary to execute the connection determination (also referred to as “connection detection”) and the detection of the liquid leak (also referred to as “leak detection”) of the liquid leak detection unit 209 by executing a control program.

The CPU 201 controls a liquid leak detection unit selection switching circuit 407 that selects one of the liquid leak detection units 209 arranged in plural portions in the printing apparatus 100 based on a start signal of the leak detection processing via a switching circuit control unit 401. In the selected liquid leak detection unit 209, a predetermined current is supplied or a predetermined voltage is applied to the pair of the wiring patterns 303. In this process, in a case where no liquid is attached between the pair of the wiring patterns 303, since the liquid leak detection unit 209 includes the element having the resistance component, the liquid leak detection unit 209 outputs a voltage based on the resistance component that the resistance element 305 has.

On the other hand, in a case where the liquid is attached between the pair of the wiring patterns 303, the liquid leak detection unit 209 outputs a voltage based on a combined component of the resistance component that the resistance element 305 has and a resistance component of the attached liquid. The obtained voltage is obtained by an A/D conversion control unit 403 included in the CPU 201, and an obtained voltage value is converted into digital data. A threshold voltage determination unit 404 compares the voltage value converted into the digital data to a threshold that is set by a threshold voltage determination unit 402, and a comparison result thereof is determined. Then, based on the determination result determined by the threshold voltage determination unit 404, a unit detection determination unit 405 determines the connection detection, and a leak detection determination unit 406 determines the leak detection.

### <Flowchart of Connection Determination and Liquid Leak Determination>

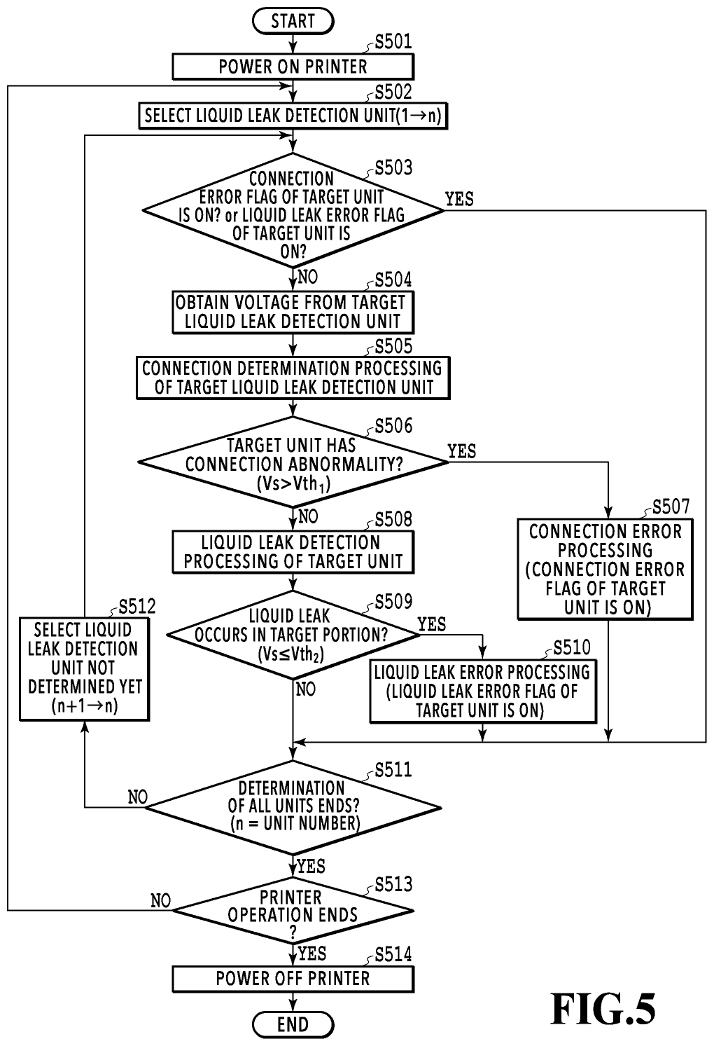

FIG. 5 is a flowchart illustrating a processing flow of the connection determination and the liquid leak determination of the liquid leak detection unit 209 according to the present embodiment. The processing illustrated in FIG. 5 is executed by the CPU 201 of the printing apparatus 100. In S501, with the printing apparatus 100 powered on, the processing flow of the connection determination and the liquid leak determination of the liquid leak detection unit 209 is started. The processing of the connection determination and the liquid leak determination constantly operates after the printing apparatus 100 is powered on. In a case where the printing apparatus 100 is powered on, a connection error flag and a liquid leak error flag are OFF. In a case where the printing apparatus 100 is powered on, the processing proceeds to S502.

In S502, the CPU 201 selects the liquid leak detection unit 209 to be a target of the leak detection. In a case where the liquid leak detection units 209 are arranged in plural different portions in the printing apparatus 100, the selected liquid leak detection unit 209 is a first liquid leak detection unit 209. Since the following processing is performed on all the liquid leak detection units 209, each selected liquid leak detection unit 209 is also called an n-th liquid leak detection unit 209. Once the liquid leak detection unit 209 is selected, the processing proceeds to S503.

In S503, the CPU 201 determines whether the connection error flag or the liquid leak error flag of the target liquid leak detection unit 209 is ON. In a case where the connection error flag or the liquid leak error flag of the target liquid leak detection unit 209 is ON, the processing proceeds to S511. In a case where the connection error flag or the liquid leak error flag of the target liquid leak detection unit 209 is OFF, the processing proceeds to S504. In S504, the CPU 201 obtains a voltage of the target liquid leak detection unit 209. The CPU 201 performs the A/D conversion of the obtained voltage (Vs) by using the A/D conversion control unit 403 and obtains a digital voltage value. In a case where the digital voltage value is obtained, the processing proceeds to S505.

In S505, in order to confirm the connection between the connector terminal 302 of the target liquid leak detection unit 209 and the A/D port 208, the CPU 201 compares the digital voltage value to a threshold of the connection detection (the connection determination processing of the liquid leak detection unit). That is, the CPU 201 compares the obtained voltage (Vs) to a threshold voltage (Vth1) of the connection detection that is to determine whether the liquid leak detection unit is connected. In a case where the digital voltage value and the threshold of the connection detection are compared to each other, the processing proceeds to S506. In S506, in a case where the comparison result is Vs>Vth1 (the obtained voltage exceeds the threshold voltage), the CPU 201 determines that the connection determination of the target liquid leak detection unit 209 is “connection abnormal”, and the processing proceeds to S507. In this case, the “connection abnormal” indicates that the electric substrate 301 including the target liquid leak detection unit 209 is not connected, a fitting failure of the connector terminal 302 on the electric substrate 301 occurs, a wire break of the wiring pattern 303 occurs, or the like. In a case where the comparison result is Vs≤Vth1 (the obtained voltage is equal to or smaller than the threshold voltage), the CPU 201 determines that the connection determination of the target liquid leak detection unit 209 is “normal connection”, and the processing proceeds to S508.

In S507, the CPU 201 displays an error on the input and output unit 109 and notifies the user of that the target liquid leak detection unit 209 has a connection error. According to the error notification number displayed on the input and output unit 109, the user can recognize that the connection error occurs in the target liquid leak detection unit 209. Additionally, the CPU 201 sets the connection error flag of the target liquid leak detection unit 209 to ON, and the processing proceeds to S511.

In S508, in order to confirm the liquid leak of the target liquid leak detection unit 209, the CPU 201 compares the digital voltage value to a threshold of the leak detection. That is, the CPU 201 compares the obtained voltage (Vs) to a threshold voltage (Vth2) of the leak detection that is to detect the liquid leak. In a case where the digital voltage value and the threshold of the leak detection are compared to each other, the processing proceeds to S509. In S509, in a case where it is determined that the comparison result is Vs>Vth2 (the obtained voltage exceeds the threshold voltage), the determination by the CPU 201 whether there is the liquid leak in the portion in which the target liquid leak detection unit 209 is arranged is “no”, and the processing proceeds to S511. In a case where it is determined that the comparison result is Vs≤Vth2 (the obtained voltage is equal to or smaller than the threshold voltage), the determination by the CPU 201 whether there is the liquid leak in the portion in which the target liquid leak detection unit 209 is arranged is “yes”, and the processing proceeds to S510.

In S510, the CPU 201 displays an error on the input and output unit 109 and notifies the user of that the liquid leak occurs in the portion in which the target liquid leak detection unit 209 is arranged (a liquid leak error). According to the error notification number displayed on the input and output unit 109, the user can recognize that the liquid leak occurs in the portion in which the target liquid leak detection unit 209 is arranged. Additionally, the CPU 201 sets the liquid leak error flag of the target liquid leak detection unit 209 to ON, and the processing proceeds to S511.

In S511, the CPU 201 determines whether the processing of the connection determination and the liquid leak determination is performed for all the liquid leak detection units 209. In a case where the processing of the connection determination and the liquid leak determination is performed for all the liquid leak detection units 209, the processing proceeds to S513. In a case where the processing of the connection determination and the liquid leak determination is not performed for all the liquid leak detection units 209, the processing proceeds to S512. In S512, in order to perform the processing of the connection determination and the liquid leak determination for the liquid leak detection unit 209 on which the determination is not performed yet, the CPU 201 increments n by “1” and selects an n+1-th liquid leak detection unit 209 by using the liquid leak detection unit selection switching circuit 407. In a case where the n+1-th liquid leak detection unit 209 is selected, the processing returns to S503.

In S513, the CPU 201 determines whether the operations of the printing apparatus 100 end. In a case where the operations of the printing apparatus 100 end, the processing proceeds to S514. In a case where the operations of the printing apparatus 100 do not end, the processing returns to S502. In S514, an operation to power off the printing apparatus 100 is executed, and the processing flow of the connection determination and the liquid leak determination ends. Note that, although it is described that the connection determination processing in S504 and the liquid leak determination processing in S509 are performed sequentially in the flowchart illustrated in FIG. 5, it is not limited thereto. A configuration to execute the connection determination processing and the liquid leak determination processing concurrently may be applied.

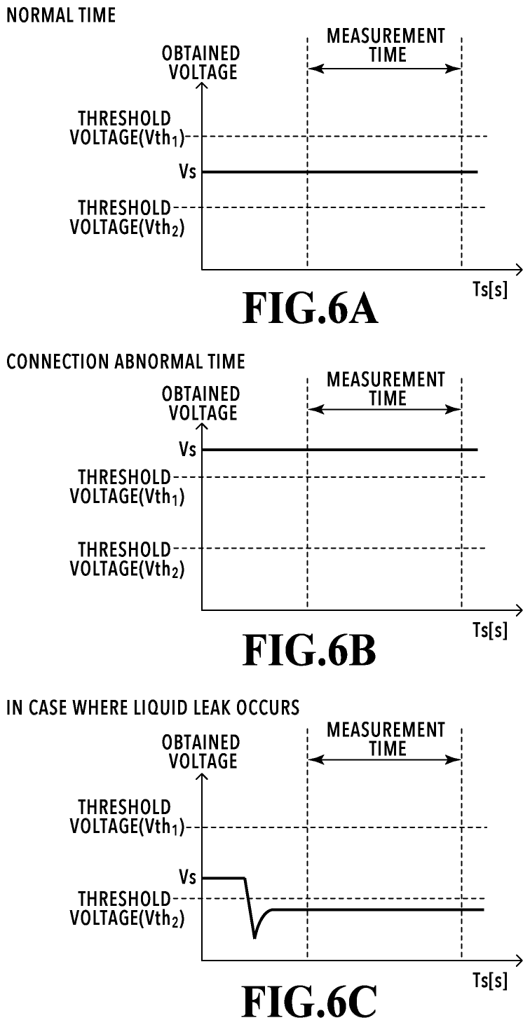

FIGS. 6A, 6B, and 6C are diagrams illustrating time changes of the obtained voltage (Vs) and the threshold voltages (Vth1 and Vth2) determined by the threshold voltage determination unit 402 according to the connection determination and the liquid leak determination of the liquid leak detection unit 209. FIG. 6A illustrates a diagram of a voltage change in a case where the target liquid leak detection unit 209 is connected normally. In a case where the liquid leak detection unit 209 is connected normally, the obtained voltage (Vs) is equal to or smaller than the threshold voltage (Vth1). In the normal time, a value based on the resistance component of the resistance element 305 is obtained as the obtained voltage (Vs). FIG. 6B illustrates a diagram of a voltage change in a case where the connection abnormality occurs in the target electric substrate 301 (the target liquid leak detection unit 209). As described above, the connection abnormality is detected also in a case where the electric substrate 301 is not connected, a fitting failure of the connector terminal 302 on the electric substrate 301 occurs, a wire break of the wiring pattern 303 occurs, or the like. In a case where the target electric substrate 301 has the connection abnormality, the obtained voltage (Vs) is higher than the threshold voltage (Vth1).

FIG. 6C illustrates a diagram of a voltage change in a case where the liquid leak is detected in the liquid leak determination of the target liquid leak detection unit 209. In a case where the liquid leak is detected, a voltage based on the combined component of the resistance component of the resistance element 305 and the resistance component of the liquid is obtained; for this reason, the obtained voltage (Vs) in a case where the liquid leak occurs is a voltage lower than the obtained voltage in a case where no liquid leak occurs. Therefore, the threshold voltage (Vth2) of the liquid leak detection is set to a lower voltage value than the threshold voltage (Vth1) of the connection detection.

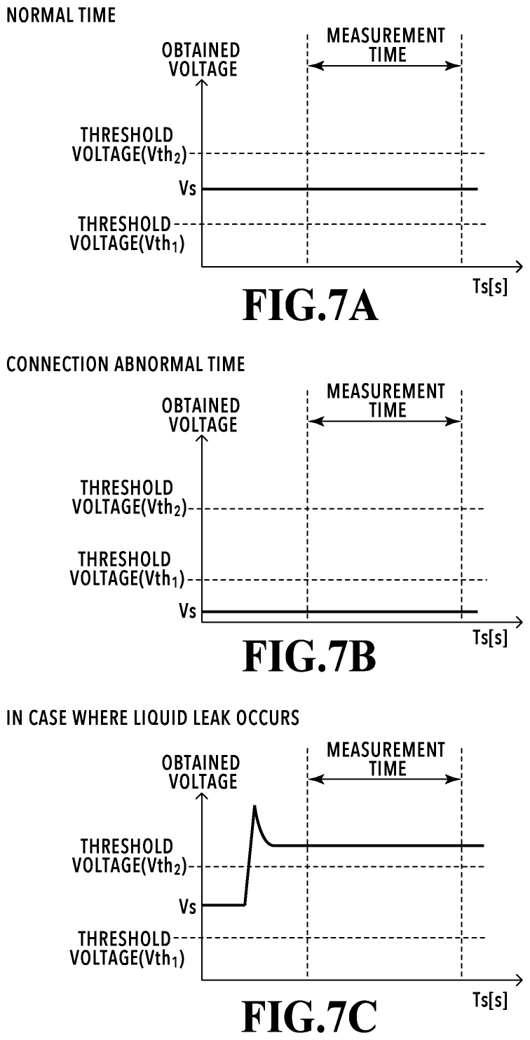

In the above-described configuration, in a case where it is determined that Vs>Vth1 (the obtained voltage exceeds the threshold voltage), it is determined that the target electric substrate 301 (the target liquid leak detection unit 209) is “connection abnormal”. As illustrated in FIG. 7B, a configuration in which the threshold voltage Vth1 that obtains Vs<Vth1 is set, and it is determined that there is “no” connection of the target liquid leak detection unit 209 may be applied. This is implemented with the configuration as follows. In the present embodiment, the wiring pattern 303 on an upper side of FIG. 3 is connected to a power supply and the CPU 201, and the wiring pattern 303 on a lower side of FIG. 3 is connected to GND. In a case where the above-described connection is inverted to connect the wiring pattern 303 on the upper side in FIG. 3 to the GND and connect the wiring pattern 303 on the lower side in FIG. 3 to the power supply and the CPU 201, a configuration in which the connection of the target electric substrate 301 is determined as “connection abnormal” in a case where Vs<Vth1 is obtained. Additionally, in this case, Vth1 is set to satisfy Vth1<Vth2. The obtained voltage in a case where the liquid leak occurs is changed as illustrated in FIG. 7C. In a case where the target liquid leak detection unit 209 operates normally, the obtained voltage illustrated in FIG. 7A is obtained.

In the present embodiment, in a case where the connection abnormality occurs, the printing apparatus 100 is powered off, and insertion of the electric substrate 301 is confirmed, or the electric substrate 301 is replaced. Additionally, also in a case where the liquid leak occurs, the printing apparatus 100 is powered off, and a member in which the liquid leak occurs is repaired, replaced, or the like as needed. Accordingly, in the present embodiment, the connection error or the liquid leak error of the target liquid leak detection unit 209 is notified only once. A method of detecting the error is not limited thereto. A processing flow that does not perform the processing in S503 may be applied. In this case, in a case where the connection error or the liquid leak error of the target liquid leak detection unit 209 occurs, the CPU 201 notifies of the connection error or the liquid leak error constantly.

As described above, according to the present embodiment, it is possible to determine the connection detection and the liquid leak detection of the liquid leak detection unit. Accordingly, it is possible to determine whether the liquid leak detection terminal operates normally and to detect the liquid leak. Therefore, the usability is improved.

### Second Embodiment

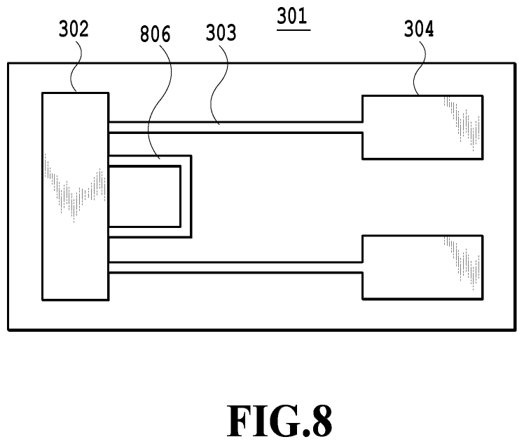

FIG. 8 is an exterior view schematically illustrating the liquid leak detection unit in the present embodiment. The wiring pattern 303 of the liquid leak detection unit 209 includes the pair (two electrodes) of the wirings and the pair (two electrodes) of the detection terminals 304. The wiring of the pair of the wiring patterns 303 is etched in the electric substrate manufacturing process, and the surface of the pair of the wiring patterns 303 is protected by resist material after a copper foil pattern is formed. On the electrode of the detection terminal 304, a pattern with gold plating is arranged on the substrate surface. In a case where the liquid is leaked, and the leak occurs between the two electrodes of the detection terminals 304, the liquid leak detection function is activated.

Additionally, a connection detection pattern 806 that is different from the wiring pattern 303 detecting the liquid leak is arranged between the pair (two electrodes) of the detection terminals 304. With use of the connection detection pattern 806, it is possible to accurately detect the occurrence of the connection abnormality that the electric substrate 301 is not connected, a fitting failure of the connector terminal 302 occurs, a wire break of the connection detection pattern 806 occurs, or the like. Moreover, with detection of a connection obtained voltage between two ends of the connection detection pattern 806 and a liquid leak obtained voltage between the wiring pattern 303 and the detection terminal 304, it is possible to determine whether the detection terminal 304 operates normally and to determine whether the liquid leak detection function can operate normally.

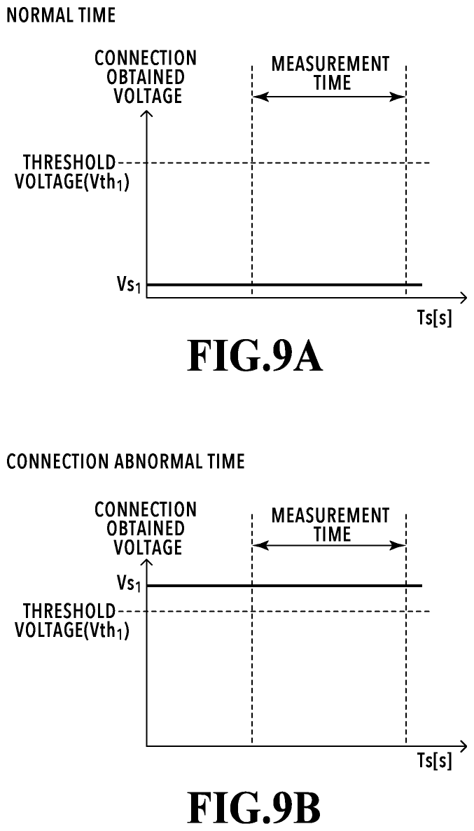

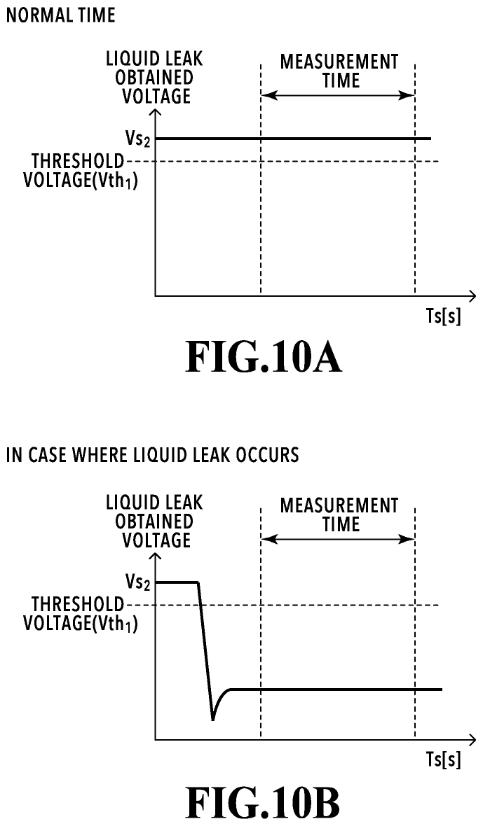

In the first embodiment, since the element 305 having the resistance component is connected between the detection terminals 304, it is impossible to widen a dynamic range of the obtained voltage Vs. The employment of the configuration of the present embodiment makes it possible to widen a dynamic range of a connection obtained voltage Vs1 with no effect of an error of the element 305 having the resistance component as illustrated in FIGS. 9A and 9B. Additionally, a liquid leak obtained voltage Vs2 in a case where the liquid leak occurs is changed over time as illustrated in FIGS. 10A and 10B. As with the connection obtained voltage, it is possible to widen a dynamic range of the liquid leak obtained voltage as well. Accordingly, in the present embodiment, it is also possible to determine whether the liquid leak detection terminal operates normally and to detect the liquid leak. In addition, it is also possible to enhance the detection accuracy of the connection and the detection accuracy of the liquid leak.

### Third Embodiment

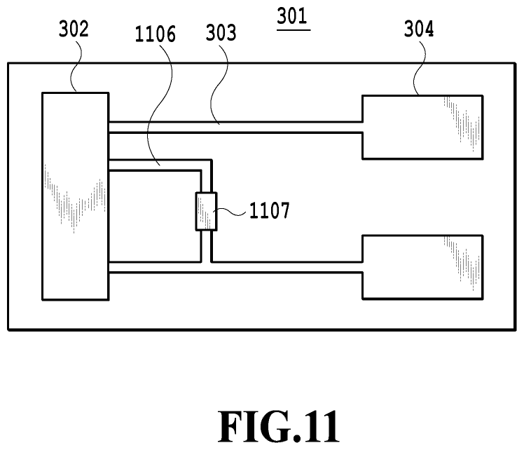

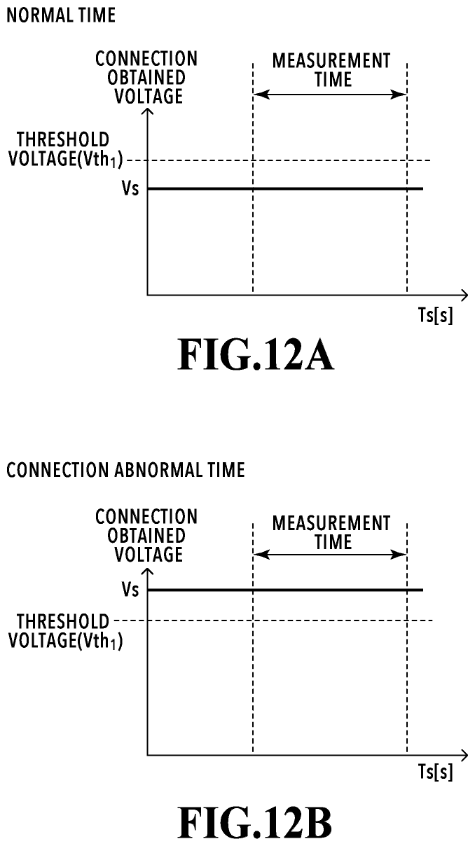

FIG. 11 is an exterior view schematically illustrating the liquid leak detection unit in the present embodiment. An element 1107 having a resistance component is arranged between connection detection patterns 1106. One end of the connection detection patterns 1106 is connected to one of the pair of the wiring patterns 303. In FIG. 11, an example in which one end of the connection detection patterns 1106 is connected to the wiring pattern 303 on a lower side in FIG. 11 is illustrated; however, one end of the connection detection patterns 1106 may be connected to the wiring pattern 303 on an upper side in FIG. 11. For example, there is a possibility that the liquid leak detection cannot be performed normally in a case where the connection abnormality that the electric substrate 301 is not connected, a fitting failure of the connector terminal 302 occurs, a wire break of the connection detection patterns 1106 occurs, or the like. The CPU 201 determines a connection state of the liquid leak detection unit 209 (the electric substrate 301) according to the connection obtained voltage Vs1 between two ends of the connection detection patterns 1106 including the element 1107 having the resistance component. As illustrated in FIG. 12A, in a case where the connection obtained voltage Vs1 is equal to or smaller than the threshold voltage Vth1, the CPU 201 determines that the liquid leak detection unit 209 (the electric substrate 301) is connected normally and operates normally. As illustrated in FIG. 12B, in a case where the connection obtained voltage Vs1 is higher than the threshold voltage Vth1, the CPU 201 determines that the liquid leak detection unit 209 (the electric substrate 301) has the connection abnormality, and it is impossible to detect the liquid leak normally. Accordingly, it is also possible to determine whether the liquid leak detection terminal operates normally and to detect the liquid leak by using the configuration of the present embodiment. Further, in the present embodiment, since the number of pins used in the electric substrate 301 is less than that in the first embodiment and the second embodiment, it is also possible to reduce an area of the liquid leak detection unit 209 (the electric substrate 301).

### Fourth Embodiment

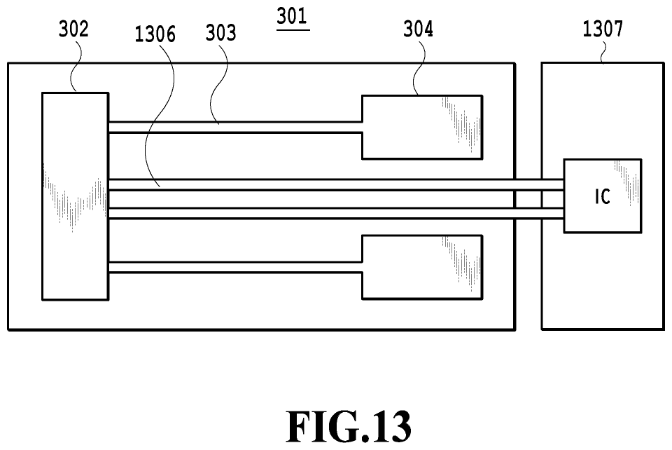

FIG. 13 is an exterior view schematically illustrating the liquid leak detection unit in the present embodiment. Between the pair (two electrodes) of the detection terminals 304, a connection detection pattern 1306 that is different from the wiring pattern 303 detecting the liquid leak is connected to a substrate 1307 that is a connection destination different from the CPU 201. The CPU 201 determines whether the electric substrate 301 is connected with the CPU 201 normally by determining a communication state between the CPU 201 and the substrate 1307. In a case where the CPU 201 and the substrate 1307 are communicable, the CPU 201 determines that the connection of the liquid leak detection unit 209 (the electric substrate 301) is normal. In a case where the CPU 201 and the substrate 1307 are not communicable, the CPU 201 determines that the liquid leak detection unit 209 (the electric substrate 301) has the connection abnormality. Accordingly, it is also possible to determine whether the liquid leak detection unit operates normally and to detect the liquid leak by using the configuration of the present embodiment.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-138895, filed Aug. 29, 2023, which is hereby incorporated by reference wherein in its entirety.

What is claimed is:

1. A printing apparatus configured to print an image by ejecting a liquid onto a printing medium, comprising:
an electric substrate including a pair of detection terminals including a wiring pattern configured to detect connection and a liquid leak of the electric substrate, and an element having a resistance component between the pair of detection terminals; and
one or more processors and/or circuitry which function as:
a determination unit configured to determine a connection state of the electric substrate and whether the liquid leak occurs in a portion in which the electric substrate is arranged, based on an obtained voltage between the pair of detection terminals, a first threshold related to the connection detection of the electric substrate, and a second threshold which is a value different from the first threshold and related to the liquid leak.

2. The printing apparatus according to claim 1, wherein
the first threshold is higher than the second threshold.

3. The printing apparatus according to claim 2, wherein
in a case where the obtained voltage is higher than the first threshold, the determination unit determines that the connection state of the electric substrate has a connection abnormality.

4. The printing apparatus according to claim 3, wherein
the connection abnormality is any one of that the electric substrate is not connected, a fitting failure of a connector on the electric substrate occurs, or a wire break of the wiring pattern on the electric substrate occurs.

5. The printing apparatus according to claim 2, wherein
in a case where the obtained voltage is lower than the second threshold, the determination unit determines that the liquid leak occurs in a portion in which the electric substrate is arranged.

6. The printing apparatus according to claim 1, wherein
the first threshold is lower than the second threshold.

7. The printing apparatus according to claim 6, wherein
in a case where the obtained voltage is lower than the first threshold, the determination unit determines that the connection state of the electric substrate has a connection abnormality.

8. The printing apparatus according to claim 6, wherein
in a case where the obtained voltage is higher than the second threshold, the determination unit determines that the liquid leak occurs in a portion in which the electric substrate is arranged.

9. The printing apparatus according to claim 1, further comprising:
a notification unit configured to notify of an error in a case where it is determined that the electric substrate has a connection abnormality, or in a case where it is determined that the liquid leak occurs in a portion in which the electric substrate is arranged.

10. The printing apparatus according to claim 9, wherein
the notification unit is a display unit configured to display the error.

11. The printing apparatus according to claim 1, wherein
the electric substrate is a plurality of the electric substrates arranged in different portions.

12. The printing apparatus according to claim 11, further comprising:
a selection switching circuit configured to select the electric substrate to be a target of the determination out of the plurality of the electric substrates.

13. A printing apparatus configured to print an image by ejecting a liquid onto a printing medium, comprising:
an electric substrate including a first wiring pattern including a pair of detection terminals configured to detect a liquid leak and a second wiring pattern different from the first wiring pattern and configured to detect connection of the electric substrate; and
one or more processors and/or circuitry which function as:
a connection determination unit configured to determine a connection state of the electric substrate by using the second wiring pattern; and
a liquid leak determination unit configured to determine whether the liquid leak occurs in a portion in which the electric substrate is arranged based on a voltage value between the pair of detection terminals and a third threshold.

14. The printing apparatus according to claim 13, wherein
in a case where a voltage value between two ends of the second wiring pattern is higher than the third threshold, the connection determination unit determines that the connection state of the electric substrate has a connection abnormality.

15. The printing apparatus according to claim 14, wherein
the connection abnormality is any one of that the electric substrate is not connected, a fitting failure of a connector on the electric substrate occurs, or a wire break of the second wiring pattern on the electric substrate occurs.

16. The printing apparatus according to claim 13, wherein
the second wiring pattern includes an element having a resistance component and is connected to the first wiring pattern.

17. The printing apparatus according to claim 13, wherein
the second wiring pattern is connected to a connection destination different from the electric substrate, and
the connection determination unit determines the connection state of the electric substrate based on a state of communication with the different connection destination via the second wiring pattern.

18. The printing apparatus according to claim 17, wherein
in a case where the connection determination unit cannot communicate with the different connection destination, the connection determination unit determines that the electric substrate has a connection abnormality.

19. The printing apparatus according to claim 13, wherein
in a case where a voltage value between the pair of detection terminals is lower than the third threshold, the liquid leak determination unit determines that the liquid leak occurs in a portion in which the electric substrate is arranged.

20. A method of controlling a printing apparatus including an electric substrate including a pair of detection terminals including a wiring pattern configured to detect connection and a liquid leak of the electric substrate, and an element having a resistance component between the pair of detection terminals, the method comprising:
obtaining an obtained voltage between the pair of detection terminals; and
determining a connection state of the electric substrate and whether the liquid leak occurs in a portion in which the electric substrate is arranged based on the obtained voltage obtained in the obtaining, a first threshold related to the connection detection of the electric substrate, and a second threshold which is a value different from the first threshold and related to the liquid leak.
